(19) United States
(12) Patent Application Publication
(10) Pub. No.: US 2024/0328809 A1
(43) Pub. Date: Oct. 3, 2024

(54) SURROUNDING DISPLAY DEVICE

(71) Applicant: AISIN CORPORATION, Kariya (JP)

(72) Inventor: Kazuya WATANABE, Kariya-shi, Aichi-ken (JP)

(73) Assignee: AISIN CORPORATION, Kariya (JP)

(21) Appl. No.: 18/607,730

(22) Filed: Mar. 18, 2024

(30) Foreign Application Priority Data
Mar. 30, 2023 (JP) 2023-055734

(51) Int. Cl. G01C 21/36; G06T 11/00

(52) U.S. Cl. CPC G01C 21/3632; G01C 21/3647; G06T 11/00

(57) ABSTRACT

A surrounding display device includes: a display processing unit that causes a display device to display a display image in which a guide line is superimposed on a surrounding image indicating a situation in surroundings of a mobile body; a detection unit that detects existence of an obstacle in a region specified by the guide line; and a change unit that changes a display mode of the guide line such that a salience of the guide line decreases when the detection unit detects the existence of the obstacle in the region.

### CROSS REFERENCE TO RELATED APPLICATIONS

This application is based on and claims priority under 35 U.S.C. § 119 to Japanese Patent Application 2023-055734, filed on Mar. 30, 2023, the entire content of which is incorporated herein by reference.

### TECHNICAL FIELD

This disclosure relates to a surrounding display device.

### BACKGROUND DISCUSSION

In a system for assisting traveling of a vehicle, a technique of displaying a guide line on an image of a front and a rear of the vehicle is known.

Examples of the related art include JP 2010-264945A (Reference 1).

In the system as described above, there is a case where a color of a part of the guide line is changed depending on a distance between a detected obstacle and the vehicle. However, in the related art, there is a possibility that the visibility of a surrounding image or the guide line is impaired or a vehicle width or the distance to the obstacle is difficult to recognize due to a change in a display mode of the guide line.

A need thus exists for a surrounding display device which is not susceptible to the drawback mentioned above.

### SUMMARY

According to an aspect of this disclosure, a surrounding display device includes a display processing unit that causes a display device to display a display image in which a guide line is superimposed on a surrounding image indicating a situation in surroundings of a mobile body, a detection unit that detects existence of an obstacle in a region specified by the guide line, and a change unit that changes a display mode of the guide line such that a salience of the guide line decreases when the detection unit detects the existence of the obstacle in the region. For example, the change unit may increase a transmittance of the guide line.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view showing an example of a configuration of a vehicle according to an embodiment;

FIG. 2 is a top view showing an example of the configuration of the vehicle according to the embodiment;

FIG. 3 is a block diagram showing an example of a system configuration of the vehicle according to the embodiment;

FIG. 4 is a block diagram showing an example of a functional configuration of a surrounding display device according to the embodiment;

FIG. 5 is a diagram showing a process of detecting an obstacle according to the embodiment;

FIG. 6 is a diagram showing a process of detecting the obstacle according to the embodiment;

FIG. 7 is a diagram showing an example of a display image according to the embodiment;

FIG. 8 is a diagram showing an example of the display image according to the embodiment;

FIG. 9 is a diagram showing an example of the display image according to the embodiment;

FIG. 10 is a diagram showing a method of determining a reference point according to the embodiment;

FIG. 11 is a diagram showing a method of determining the reference point according to the embodiment; and

FIG. 12 is a flowchart showing an example of a process in the surrounding display device according to the embodiment.

### DETAILED DESCRIPTION

Hereinafter, an exemplary embodiment disclosed here will be described. The configurations of the following embodiment, and the actions, results, and effects brought about by the configurations are examples. The present disclosure can be realized by configurations other than configurations disclosed in the following embodiment, and can achieve at least one of various effects based on the fundamental configurations and derivative effects.

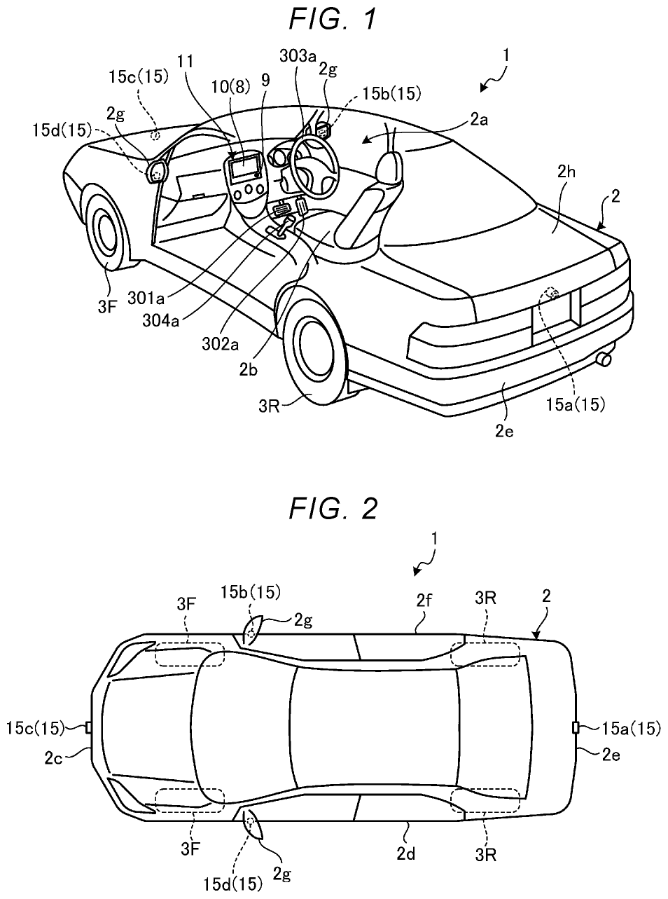

FIG. 1 is a perspective view showing an example of a configuration of a vehicle 1 according to the embodiment. FIG. 2 is a top view showing an example of the configuration of the vehicle 1 according to the embodiment.

As shown in FIG. 1, the vehicle 1 as an example of a mobile body has a vehicle cabin 2a in which an occupant including a driver as a user is seated. In the vehicle cabin 2a, a brake unit 301a, an acceleration unit 302a, a steering unit 303a, a transmission unit 304a, and the like are provided in a state where the user can perform operations on a seat 2b.

The brake unit 301a is, for example, a brake pedal provided under the driver's foot, and the acceleration unit 302a is, for example, an accelerator pedal provided under the driver's foot. The steering unit 303a is, for example, a steering wheel protruding from a dashboard (instrument panel), and the transmission unit 304a is, for example, a shift lever protruding from a center console. The steering unit 303a may be a handlebar.

A monitor device 11 including a display unit 8 that can output various images and a sound output unit 9 that can output various sounds is provided in the vehicle cabin 2a. The monitor device 11 is provided, for example, in a central portion in a width direction (right-left direction) of the dashboard in the vehicle cabin 2a. The display unit 8 is configured with, for example, a liquid crystal display (LCD) or an organic electroluminescence display (OELD).

Here, an operation input unit 10 is provided on a display screen as a region in which an image is displayed in the display unit 8. The operation input unit 10 is configured as, for example, a touch panel that can detect coordinates of a position at which an indicator such as a finger or a stylus is in close proximity (including contact). Accordingly, the user (driver) can visually recognize the image displayed on the display screen of the display unit 8, and can execute various operation inputs by performing a touch (tap) operation or the like using the indicator on the operation input unit 10.

In the embodiment, the operation input unit 10 may be various physical interfaces such as a switch, a dial, a joystick, and a push button. In the embodiment, another sound output device may be provided at a position different from a position of the monitor device 11 in the vehicle cabin 2a. In this case, various sound information may be output from both the sound output unit 9 and the other sound output device. In the embodiment, the monitor device 11 may be configured to display information on various systems such as a navigation system and an audio system.

As shown in FIGS. 1 and 2, the vehicle 1 according to the embodiment is configured as a four-wheeled vehicle including two right and left front vehicle wheels 3F and two right and left rear vehicle wheels 3R. Hereinafter, for the sake of simplicity, the front vehicle wheels 3F and the rear vehicle wheels 3R may be collectively referred to as vehicle wheels. In the embodiment, a sideslip angle of a part or all of the four vehicle wheels is changed (turned) in response to an operation of the steering unit 303a or the like.

The vehicle 1 is equipped with a plurality of (four in the example shown in FIGS. 1 and 2) in-vehicle cameras 15a to 15d as imaging devices for monitoring the surrounding. The in-vehicle camera 15a is provided at a rear end portion 2e of a vehicle body 2 (for example, below a rear trunk door 2h), and images a rearward region of the vehicle 1. The in-vehicle camera 15b is provided on a side-view mirror 2g at a right end portion 2f of the vehicle body 2, and images a rightward region of the vehicle 1. The in-vehicle camera 15c is provided at a front end portion 2c (for example, a front bumper) of the vehicle body 2, and images a frontward region of the vehicle 1. The in-vehicle camera 15d is provided on the side-view mirror 2g at a left end portion 2d of the vehicle body 2, and images a leftward region of the vehicle 1. Hereinafter, for the sake of simplicity, the in-vehicle cameras 15a to 15d may be collectively referred to as an in-vehicle camera 15.

The in-vehicle camera 15 is, for example, a so-called digital camera including an imaging element such as a charge-coupled device (CCD) or a complementary metal oxide semiconductor (CMOS) image sensor (CIS). The in-vehicle camera 15 images the surroundings of the vehicle 1 at a predetermined frame rate to output image data of a captured image obtained by the imaging. The image data obtained by the in-vehicle camera 15 may form a moving image as a frame image.

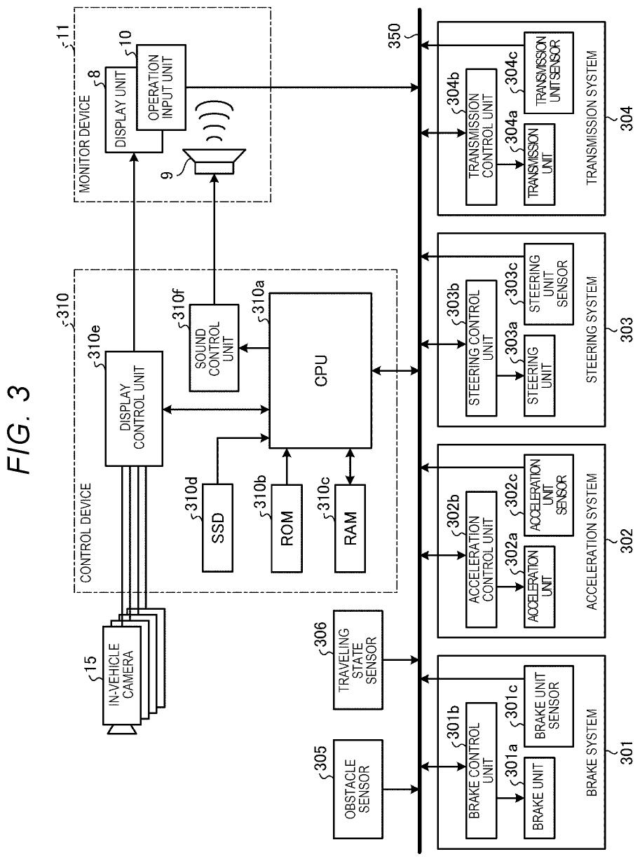

Hereinafter, a system configuration provided to realize various controls in the vehicle 1 according to the embodiment will be described with reference to FIG. 3. The system configuration shown in FIG. 3 is merely an example and can be set (changed) in various ways.

FIG. 3 is a block diagram showing an example of the system configuration of the vehicle 1 according to the embodiment. As shown in FIG. 3, the vehicle 1 includes a brake system 301, an acceleration system 302, a steering system 303, a transmission system 304, an obstacle sensor 305, a traveling state sensor 306, the in-vehicle camera 15, the monitor device 11, a control device 310, and an in-vehicle network 350.

The brake system 301 controls deceleration of the vehicle 1. The brake system 301 includes the brake unit 301a, a brake control unit 301b, and a brake unit sensor 301c.

The brake unit 301a is a device for decelerating the vehicle 1, such as the brake pedal described above.

The brake control unit 301b is configured as a microcomputer including a hardware processor such as a central processing unit (CPU). The brake control unit 301b controls a deceleration degree of the vehicle 1 by, for example, driving an actuator based on the instruction input through the in-vehicle network 350 to operate the brake unit 301a.

The brake unit sensor 301c is a sensing device for detecting a state of the brake unit 301a. For example, in a case where the brake unit 301a is configured as the brake pedal, the brake unit sensor 301c detects a position of the brake pedal or a pressure acting on the brake pedal as the state of the brake unit 301a. The brake unit sensor 301c outputs the detected state of the brake unit 301a to the in-vehicle network 350.

The acceleration system 302 controls acceleration of the vehicle 1. The acceleration system 302 includes the acceleration unit 302a, an acceleration control unit 302b, and an acceleration unit sensor 302c.

The acceleration unit 302a is a device for accelerating the vehicle 1, such as the accelerator pedal described above.

The acceleration control unit 302b is configured as a microcomputer including a hardware processor such as a CPU. The acceleration control unit 302b controls an acceleration degree of the vehicle 1 by, for example, driving the actuator based on the instruction input through the in-vehicle network 350 to operate the acceleration unit 302a.

The acceleration unit sensor 302c is a sensing device for detecting a state of the acceleration unit 302a. For example, in a case where the acceleration unit 302a is configured as the accelerator pedal, the acceleration unit sensor 302c detects a position of the accelerator pedal or a pressure acting on the accelerator pedal. The acceleration unit sensor 302c outputs the detected state of the acceleration unit 302a to the in-vehicle network 350.

The steering system 303 controls an advancing direction of the vehicle 1. The steering system 303 includes the steering unit 303a, a steering control unit 303b, and a steering unit sensor 303c.

The steering unit 303a is a device that turns a turning wheel of the vehicle 1, such as the steering wheel or the handlebar described above.

The steering control unit 303b is configured as a microcomputer including a hardware processor such as a CPU. The steering control unit 303b controls the advancing direction of the vehicle 1 by, for example, driving the actuator based on the instruction input through the in-vehicle network 350 to operate the steering unit 303a.

The steering unit sensor 303c is a sensing device for detecting a state of the steering unit 303a, that is, a steering angle sensor for detecting a steering angle of the vehicle 1. For example, in a case where the steering unit 303a is configured as the steering wheel, the steering unit sensor 303c detects a position of the steering wheel or a rotation angle of the steering wheel. In a case where the steering unit 303a is configured as the handlebar, the steering unit sensor 303c may detect a position of the handlebar or a pressure acting on the handlebar. The steering unit sensor 303c outputs the detected state of the steering unit 303a to the in-vehicle network 350.

The transmission system 304 controls a gear ratio of the vehicle 1. The transmission system 304 includes the transmission unit 304a, a transmission control unit 304b, and a transmission unit sensor 304c.

The transmission unit 304a is a device for changing the gear ratio of the vehicle 1, such as the shift lever described above.

The transmission control unit 304b is configured as a computer including a hardware processor such as a CPU. The transmission control unit 304b controls the gear ratio of the vehicle 1 by, for example, driving the actuator based on the instruction input through the in-vehicle network 350 to operate the transmission unit 304a.

The transmission unit sensor 304c is a sensing device for detecting a state of the transmission unit 304a. For example, in a case where the transmission unit 304a is configured as the shift lever, the transmission unit sensor 304c detects a position of the shift lever or a pressure acting on the shift lever. The transmission unit sensor 304c outputs the detected state of the transmission unit 304a to the in-vehicle network 350.

The obstacle sensor 305 is a sensing device for detecting information on an object (obstacle) which may exist in surroundings of the vehicle 1. The obstacle sensor 305 includes, for example, a distance measurement sensor that acquires a distance to the object existing in surroundings of the vehicle 1. As the distance measurement sensor, for example, an ultrasonic sensor, a millimeter wave radar, or a laser radar can be used. The obstacle sensor 305 outputs the detected information to the in-vehicle network 350.

The traveling state sensor 306 is a device for detecting a traveling state of the vehicle 1. The traveling state sensor 306 may include, for example, a vehicle wheel sensor that detects a vehicle wheel speed of the vehicle 1, an acceleration sensor that detects the acceleration in the front-rear direction or the right-left direction of the vehicle 1, or a gyro sensor that detects a turning speed (angular speed) of the vehicle 1. The traveling state sensor 306 outputs the detected traveling state to the in-vehicle network 350.

The control device 310 is an information processing device that comprehensively controls various systems provided in the vehicle 1. The control device 310 according to the embodiment has a function of generating a surrounding image indicating a situation in surroundings of the vehicle 1 based on the captured image (image data of the captured image) captured by the in-vehicle camera 15, and displaying a display image in which a guide line indicating a predictive route of the vehicle 1 is superimposed on the surrounding image on the display unit 8. The surrounding image is an image when a projection image obtained by projecting the captured image onto a projection plane corresponding to a three-dimensional space in surroundings of the vehicle is viewed from a predetermined virtual viewpoint. The surrounding image may also include a bird's-eye view image obtained by viewing the situation in surroundings of the vehicle 1 from above in a bird's-eye view, a single camera image that is an image based on only one image data acquired from one in-vehicle camera 15, and the like, in addition to the three-dimensional image.

The control device 310 according to the embodiment is configured as a microcomputer including a CPU 310a, a read-only memory (ROM) 310b, a random access memory (RAM) 310c, a solid state drive (SSD) 310d, a display control unit 310e, and a sound control unit 310f.

The CPU 310a is a hardware processor that comprehensively controls the control device 310. The CPU 310a reads various programs stored in the ROM 310b and the like, and realizes various functions in response to instructions defined in the programs. The programs described here include a program for executing a process of displaying the display image as described above on the display unit 8.

The ROM 310b is a non-volatile main storage device that stores parameters and the like required to execute the programs described above.

The RAM 310c is a volatile main storage device that provides a work area for the CPU 310a.

The SSD 310d is a rewritable non-volatile auxiliary storage device. As the auxiliary storage device, a hard disk drive (HDD) may be provided instead of or in addition to the SSD 310d.

The display control unit 310e mainly controls image processing on the captured image obtained from the in-vehicle camera 15, generation of the image data to be output to the display unit 8 of the monitor device 11, or the like among various processes executed by the control device 310.

The sound control unit 310f mainly controls generation of sound data to be output to the sound output unit 9 of the monitor device 11 or the like among the various processes executed by the control device 310.

The in-vehicle network 350 communicably connects the brake system 301, the acceleration system 302, the steering system 303, the transmission system 304, the obstacle sensor 305, the traveling state sensor 306, the operation input unit 10 of the monitor device 11, and the control device 310 to each other.

The guide line is superimposed and displayed on the surrounding image. In addition, when the obstacle existing in surroundings of the vehicle 1 is detected, a marker indicating a position of the obstacle may be further displayed. In such a case, there is a problem that the obstacle itself is difficult to see in the surrounding image due to the influence of the marker and the guide line.

In addition, a depth may be expressed by a change in a thickness of the guide line. On the other hand, depending on a length of the guide line, the depth may not be able to be expressed in a sufficiently perceptible way, the guide line may appear to be floating from the ground, and the vehicle width or the distance to the obstacle may be difficult to grasp.

Therefore, in the embodiment, the surrounding display device having a function for solving the above-described problem is realized in the control device 310.

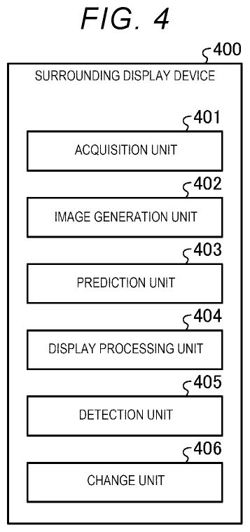

FIG. 4 is a block diagram showing an example of a functional configuration of a surrounding display device 400 according to the embodiment. The surrounding display device 400 according to the present embodiment includes an acquisition unit 401, an image generation unit 402, a prediction unit 403, a display processing unit 404, a detection unit 405, and a change unit 406. These functional units 401 to 406 may be configured by the cooperation of hardware elements and software elements (programs) constituting the control device 310. In addition, at least one of the functional units 401 to 406 may be configured by dedicated hardware (circuit or the like).

The acquisition unit 401 acquires information necessary for displaying the display image in which the guide line is superimposed and displayed on the surrounding image. The information includes the captured image captured by the in-vehicle camera 15, vehicle information (an example of mobile body information) on the vehicle 1, and the like. The vehicle information includes the advancing direction, the steering angle, a vehicle body size, and the like of the vehicle 1. The vehicle body size includes a wheel base (wheelbase) and the like.

The image generation unit 402 generates the surrounding image indicating the situation in surroundings of the vehicle 1 based on the captured image acquired by the acquisition unit 401. A specific aspect of the surrounding image is not particularly limited, but may be, for example, an image when the projection image obtained by projecting the captured image onto the projection plane corresponding to a three-dimensional space in surroundings of the vehicle 1 is viewed from the predetermined virtual viewpoint. The captured image may be used as the surrounding image as it is without being projected onto the projection plane. An example of the surrounding image will be described later.

The prediction unit 403 predicts a future route of the vehicle 1 based on the vehicle information acquired by the acquisition unit 401. A method of predicting the route is not particularly limited, but for example, the route can be predicted based on the advancing direction, the steering angle, and the like of the vehicle 1 included in the vehicle information.

The display processing unit 404 causes the display device (display unit 8 of the monitor device 11 in the present embodiment) to display the display image in which the guide line is superimposed on the surrounding image indicating the situation in surroundings of the mobile body. The display processing unit 404 performs a line width adjustment process of adjusting a width of the guide line such that the guide line is thinner as the guide line is farther from the vehicle 1 in the display image.

Here, in the present embodiment, it is assumed that the guide line includes a fixed guide line and a predictive guide line. The display processing unit 404 changes a shape of the predictive guide line in accordance with the route (predictive route) predicted by the prediction unit 403. On the other hand, the display processing unit 404 does not change a shape of the fixed guide line regardless of the route (predictive route) predicted by the prediction unit 403.

The display processing unit 404 causes the display device (display unit 8 of the monitor device 11 in the present embodiment) to display the display image in which the guide line indicating the predictive route is superimposed on the surrounding image, based on the surrounding image generated by the image generation unit 402 and the route (predictive route) predicted by the prediction unit 403.

In the present embodiment, a process of changing the visibility of the fixed guide line will be described. Hereinafter, unless otherwise specified, the guide line means the fixed guide line. It should be noted that the process described here may be applied to the predictive guide line.

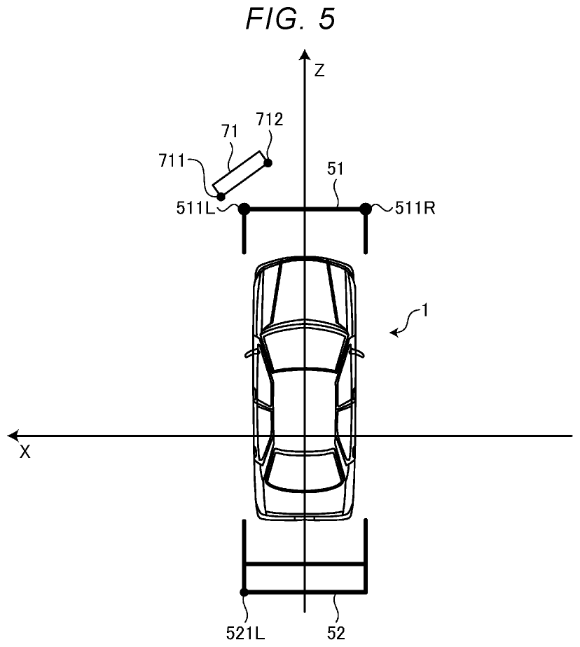

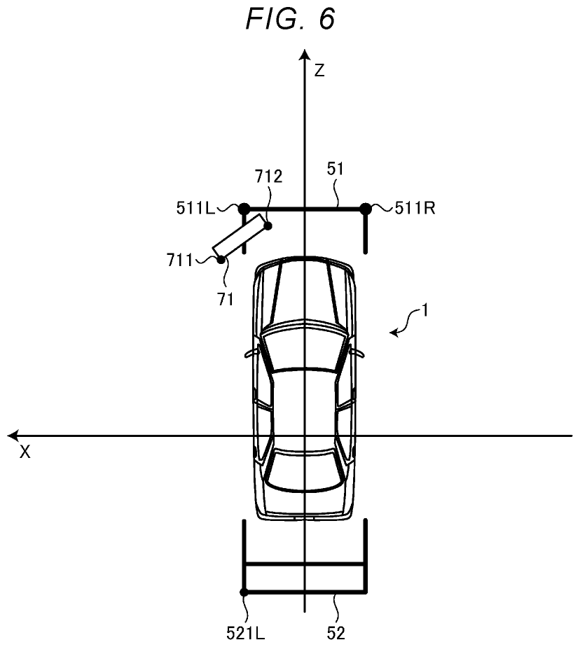

The detection unit 405 detect the existence of the obstacle in a region specified by the guide line. A process in which the detection unit 405 detects the obstacle will be described with reference to FIGS. 5 and 6. FIGS. 5 and 6 are diagrams showing the process of detecting the obstacle according to the embodiment.

In FIG. 5, the vehicle 1 viewed from above in a bird's-eye view, a fixed guide line 51 displayed in front of the vehicle 1, a fixed guide line 52 displayed behind the vehicle 1, and an obstacle 71 are disposed. In addition, FIG. 5 shows a Z-axis parallel to a horizontal ground on which it is assumed that the vehicle 1 is located, passing through a center of the vehicle 1, and having a front side as a positive direction, and an X-axis parallel to the ground and perpendicular to the Z-axis.

In FIG. 5, a positional relationship between the guide line 51, the guide line 52, and the obstacle 71 with respect to the vehicle 1 is shown for the sake of description. The display processing unit 404 may display the display image as shown in FIG. 5, but does not necessarily display the display image as shown in FIG. 5.

The display processing unit 404 displays the guide line having a shape in which a line segment parallel to a direction of the mobile body and a line segment perpendicular to the direction of the mobile body are combined.

The detection unit 405 detects the existence of the object in the region specified by each guide line using the coordinates of the two points on an XZ plane in which the existence of the object is detected.

The coordinates of the two points are acquired from the obstacle sensor 305 by the acquisition unit 401. The obstacle sensor 305 may be a system configured with a plurality of ultrasonic sensors, that is, a sonar array. The obstacle sensor 305 may detect the obstacle by using a millimeter wave radar or may detect the obstacle by image recognition. The obstacle sensor 305 can deliver the coordinates of the two points to the acquisition unit 401 regardless of the method of detecting the obstacle.

The acquisition unit 401 acquires the coordinates of the two points (point 711 and point 712) of the obstacle 71 on the XZ plane from the sonar array. The two points are merely two points at which the existence of the object is detected by the obstacle sensor 305, and the existence of the obstacle 71 is not necessarily recognized by the obstacle sensor 305 or the surrounding display device 400.

It is assumed that the acquisition unit 401 acquires the coordinates (x₁, z₁) and (x₂, z₂) on the XZ plane of each of the point 711 and the point 712.

The detection unit 405 obtains absolute values of values of the coordinates (x₁, z₁) and (x₂, z₂) and converts the values into (|x₁|, |z₁|) and (|×2|, |z₂|).

In addition, a point 511L in FIG. 5 is a reference point. The coordinates of the reference point are (x, z). The detection unit 405 obtains an absolute value of each value of the coordinates (x, z) of the reference point and converts the value into (|x|, |z|).

The point 511L, which is the reference point, is an intersection point of the line segments constituting the guide line 51. It should be noted that the reference point is not limited to the intersection point of the line segments, and may be a point at which a relative positional relationship with the guide line 51 is defined in advance.

In the example of FIG. 5, x₁, z₁, x₂, z₂, x, and z are all positive values. Even when any of the values is negative, the detection unit 405 can simplify the calculation by converting each value into a value in the first quadrant (a region in which both the value of the X-axis and the value of the Z-axis are positive).

Subsequently, the detection unit 405 determines whether the detected object (obstacle 71) exists in the region specified by the guide line 51, based on the positive or negative of Determination Expression (1).

|z₂|−|z₁|/|x₂|−|x₁|(|x|−|x₁|)−(|z|−|z₁|) (1)

When Determination Expression (1) is larger than 0, the detection unit 405 determines that the detected object exists outside the region specified by the guide line 51. In addition, when Determination Expression (1) is equal to or less than 0, the detection unit 405 determines that the detected object exists in the region specified by the guide line 51. That is, when Determination Expression (1) is equal to or less than 0, the detection unit 405 detects the existence of the obstacle in the region.

The fact that Determination Expression (1) is equal to or less than 0 means that some points on a straight line passing through the point 711 and the point 712 (hereinafter, detection straight line) are on an origin side (vehicle 1 side) with respect to the point 511L which is the reference point. An origin is an intersection point between the X-axis and the Z-axis. In this case, in the display image, an object or the like indicating the obstacle 71 or a position of the obstacle 71 may overlap with the guide line 51, and the visibility of the guide line 51 may decrease.

When the guide line 51 and the obstacle 71 are in the positional relationship shown in FIG. 5, all the points on the straight line passing through the point 711 and the point 712 are at positions farther from the origin with respect to the point 511L which is the reference point, and thus the detection unit 405 does not detect the existence of the obstacle in the region.

On the other hand, when the guide line 51 and the obstacle 71 are in the positional relationship shown in FIG. 6, some points on the detection straight line are on the origin side with respect to the point 511L, which is the reference point, and thus the detection unit 405 detects the existence of the obstacle in the region.

In addition, a distance from the origin to the point 511L, which is the reference point, is referred to as a reference distance, and the process of the detection unit 405 can be rephrased as follows. That is, the detection unit 405 detect the existence of the obstacle in the region in a case where the distance between the origin and the detection straight line is less than the reference distance.

Further, even when the obstacle 71 exists on a right front side of the vehicle 1, that is, in the second quadrant (region in which the value of the X-axis is negative and the value of the Z-axis is positive), the detection unit 405 can perform the calculation with a point 511L as the reference point. It should be noted that the detection unit 405 may perform the calculation with the point 511R located on the right front side of the vehicle 1 as the reference point. When the point 511R is located at a position of the point 511L for the Z-axis, the coordinates of the point 511L after the conversion are the same as the coordinates of the point 511R.

In addition, when the obstacle sensor 305 detects an object behind the vehicle 1, that is, when z₁ and z₂ in the coordinates (x₁, z₁) and (x₂, z₂) are negative, the detection unit 405 performs the calculation using the reference point (for example, a point 521L) defined based on the guide line 52.

The object in front of the vehicle 1 is detected by a front sonar provided on the front side of the vehicle 1 in the sonar array. On the other hand, the object behind the vehicle 1 is detected by a rear sonar provided on a rear side of the vehicle 1 in the sonar array.

In the example of FIG. 5, there are four intersection points between the line segments constituting the guide line 52. The point 521L, which is the reference point, is the intersection point farthest from the origin (vehicle 1) among the four intersection points. In addition, the position, the shape, and the size of the front guide line 51 and the rear guide line 52 may be different from each other.

When the detection unit 405 detects the existence of the obstacle in the region, the change unit 406 changes the display mode of the guide line such that the salience of the guide line is lower than the salience of the surrounding image. The change unit 406 can reduce the salience by, for example, making the guide line less conspicuous. It should be noted that the change unit 406 does not perform a change (for example, erasing the guide line) that significantly deteriorates the visibility of the guide line. The change unit 406 changes the display mode to reduce the salience of the guide line, to achieve a balance between the guide line and the surrounding image, and to improve the visibility of the entire display image.

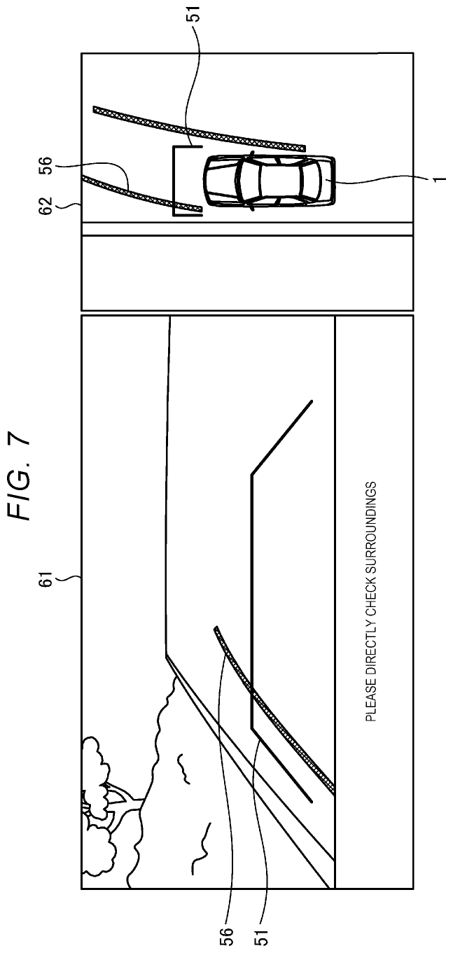

The change of the display mode will be described with reference to an example of the display image. FIG. 7 is a diagram showing an example of the display image according to the embodiment. A display image 61 is an image based on the surrounding image (front view) in front of the vehicle 1. A display image 62 is an image based on the bird's-eye view image of the vehicle 1.

The guide line 51 and a guide line 56 are displayed on the display image 61 and the display image 62. The guide line 51 is the fixed guide line. The guide line 56 is the predictive guide line.

In the example in FIG. 7, the detection unit 405 does not detect the existence of the obstacle in the region. Therefore, the display mode of the guide line 51 is an initial state before the change.

For example, the change unit 406 increases the transmittance of the guide line in the display image when the detection unit 405 detects the existence of the obstacle in the region. In addition, in the initial state, the transmittance of the guide line is 0%. In this case, only the guide line 51 is displayed in a pixel at which the guide line 51 is located in the display image.

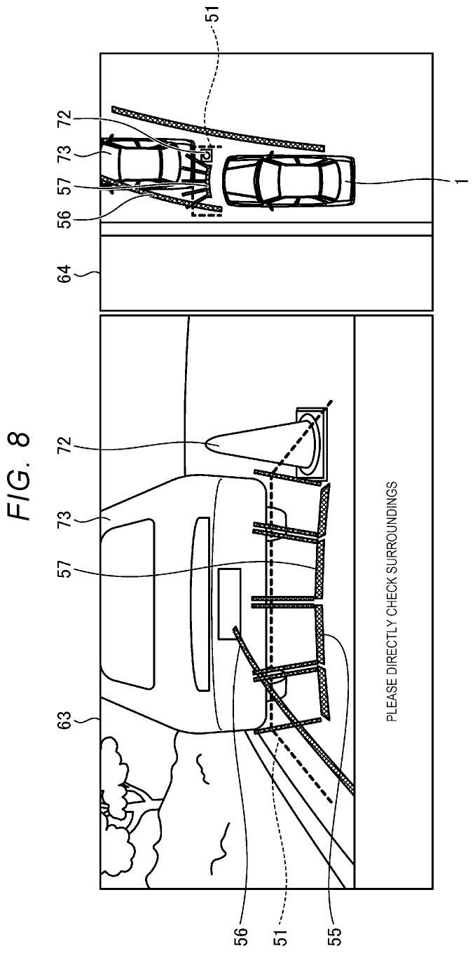

FIG. 8 is a diagram showing an example of the display image according to the embodiment. A display image 63 is an image based on the surrounding image (front view) in front of the vehicle 1. A display image 64 is an image based on the bird's-eye view image of the vehicle 1.

In the example in FIG. 8, the detection unit 405 detects the existence of the obstacle (obstacle 72 or obstacle 73) in the region. Therefore, the display mode of the guide line 51 is changed by the change unit 406.

For example, the change unit 406 makes the transmittance of the guide line 51 higher than 0%. Accordingly, in the display image, at a pixel at which the guide line 51 is located, a pixel at which the guide line 51 and the surrounding image are combined is displayed. For example, when the change unit 406 changes the transmittance of the guide line 51 to 70%, at the pixel at which the guide line 51 is located, a weighted sum obtained by giving a weight of 30% to a pixel value of the guide line 51, giving a weight of 70% to a pixel value of the surrounding image, and adding up the respective pixel values is set as a pixel value.

The change of the display mode by the change unit 406 is not limited to the change of the transmittance. The change unit 406 can change the display mode by a method of reducing the salience of the guide line 51. For example, the change unit 406 may change the display mode by thinning the line, lightening the color, or the like. Also, the change unit 406 may gradually change the display mode by animation.

It should be noted that the change unit 406 changes the display mode while maintaining the shape of the guide line 51 which is the fixed guide line. This is because the guide line 51 does not function as the fixed guide line when the shape of the guide line 51 is changed.

In addition, as shown in FIG. 8, when the obstacle is detected, the display processing unit 404 displays a marker 57 indicating the position of the obstacle. The guide line 51 may overlap with the marker 57 in addition to the obstacle. By changing the display mode by the change unit 406, the guide line 51 does not overlap with the marker 57, and the guide line 51 is prevented from being seen in a state of floating. In FIG. 8, the guide line 51 is indicated by a broken line, but this illustration does not mean that the display mode is changed from a solid line to a broken line, but simply means that the display mode is changed.

The change unit 406 returns the display mode of the guide line 51 to a state before the change when the detection unit 405 does not detect the existence of the obstacle in the region for a predetermined time after the display mode of the guide line 51 is changed. Accordingly, the change unit 406 can make the guide line 51 conspicuous during the period in which the guide line 51 does not overlap with the obstacle.

For example, the change unit 406 returns the transmittance of the guide line 51 to 0% when the detection unit 405 does not detect the existence of the obstacle in the region for 2 seconds after the transmittance of the guide line 51 is changed from 0% to 70%.

The shape of the fixed guide line is not limited to the example described above. The guide lines 51 and 52 shown in FIG. 5 are closed frontward or rearward. On the other hand, the shape of the fixed guide line may not be closed forward or rearward.

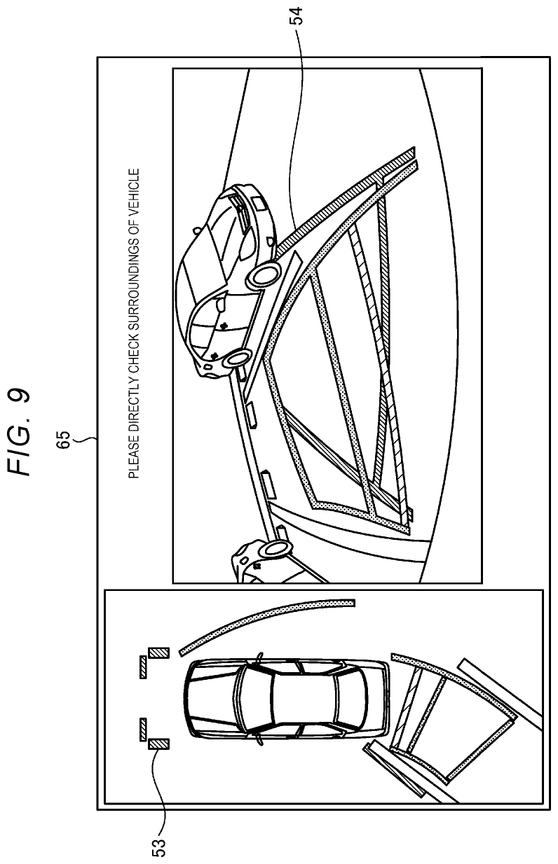

FIG. 9 is a diagram showing an example of the display image according to the embodiment. Guide lines 53 and 54, which are the fixed guide lines, are displayed on a display image 65.

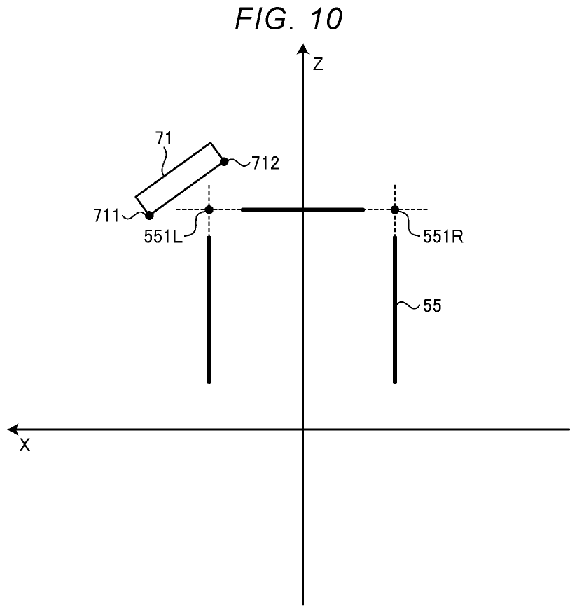

As shown in FIG. 9, line segments constituting the guide line 53 are not in contact with each other. Therefore, the guide line 53 is not closed forward. In this case, as shown in FIG. 10, the detection unit 405 determines an intersection point (point 551L or point 551R) of the straight lines including the respective line segments as the reference point, and performs the detection. FIG. 10 is a diagram showing a method of determining the reference point according to the embodiment.

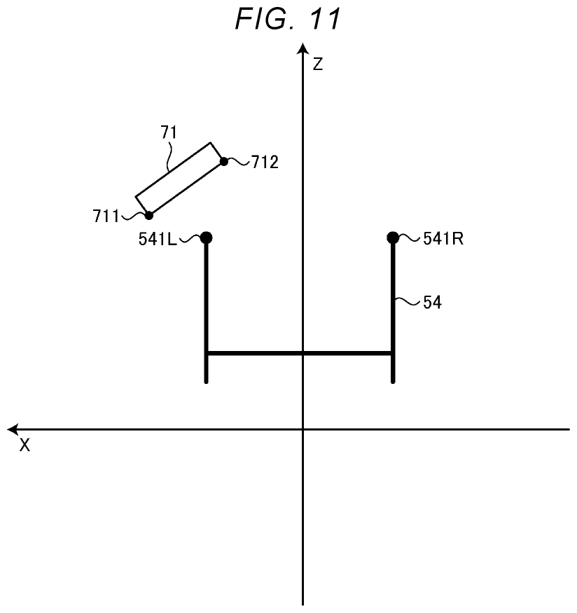

In addition, as shown in FIG. 9, in the guide line 54, a part of the line segment extends rearward from the intersection point, and the guide line 54 is not closed rearward. In this case, as shown in FIG. 11, the detection unit 405 determines the end points (point 541L or point 541R) of the line segment as the reference points, and performs the detection. FIG. 11 is a diagram showing a method of determining the reference point according to the embodiment.

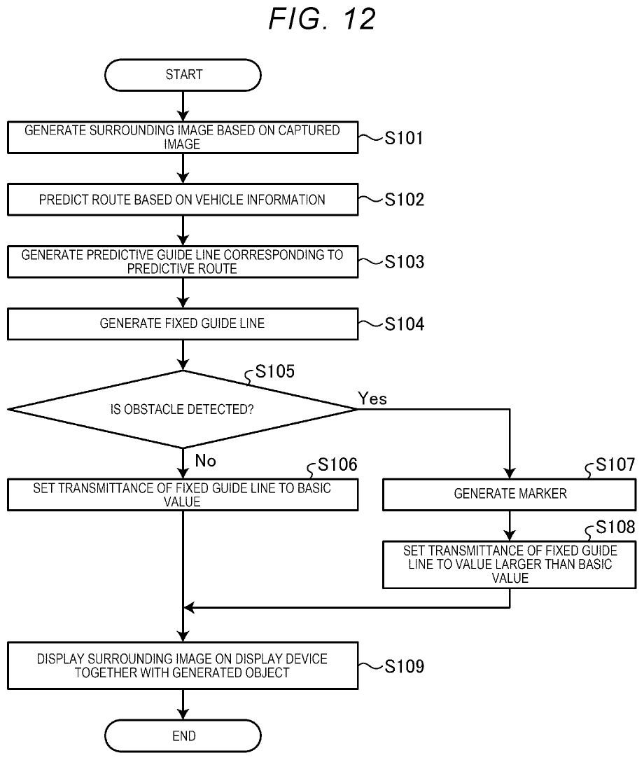

FIG. 12 is a flowchart showing an example of a process in the surrounding display device 400 according to the embodiment. The image generation unit 402 generates the surrounding image based on the captured image obtained by imaging the surroundings of the vehicle 1 with the in-vehicle camera 15 (S101). The prediction unit 403 predicts the route of the vehicle 1 based on the vehicle information (for example, the steering angle and the wheel base) acquired via an in-vehicle network such as a controller area network (CAN) (S102).

The display processing unit 404 generates the predictive guide line corresponding to the route predicted by the prediction unit 403 (S103). The display processing unit 404 generates the fixed guide line.

When the detection unit 405 does not detect the existence of the obstacle in the region specified by the fixed guide line (step S105, No), the display processing unit 404 sets the transmittance of the fixed guide line to a basic value (for example, 0%) (step S106).

When the detection unit 405 detects the obstacle in the region specified by the fixed guide line (step S105, Yes), the display processing unit 404 generates the marker indicating the position of the obstacle (step S107). The change unit 406 changes the transmittance of the fixed guide line to a value larger than the basic value (for example, 70%) (step S108).

The display processing unit 404 displays the surrounding image on the display device together with the generated object (step S109). That is, the display processing unit 404 displays the display image. The object includes the guide line and the marker.

A configuration may be adopted in which a program for causing a computer (for example, the control device 310) to realize the function of the surrounding display device 400 of the embodiment described above or the modification example is provided by being recorded on a computer readable recording medium such as a CD-ROM, a flexible disk (FD), a CD-R, or a digital versatile disk (DVD) in a file format that can be installed or an executable file format.

In addition, a configuration may be adopted in which the program is provided by storing the program on a computer connected to a network such as the Internet and downloading the program through the network. In addition, a configuration may be adopted in which the program is provided or distributed through a network such as the Internet.

According to an aspect of this disclosure, a surrounding display device includes a display processing unit that causes a display device to display a display image in which a guide line is superimposed on a surrounding image indicating a situation in surroundings of a mobile body, a detection unit that detects existence of an obstacle in a region specified by the guide line, and a change unit that changes a display mode of the guide line such that a salience of the guide line decreases when the detection unit detects the existence of the obstacle in the region. For example, the change unit may increase a transmittance of the guide line.

Accordingly, particularly when the guide line and the obstacle in the surrounding image overlap with each other, it is possible to display an image in which both the surrounding image and the guide line are clearly visible and a vehicle width or a distance to the obstacle is easily grasped.

In the configuration described above, the change unit may return the display mode of the guide line to a state before the change when the detection unit does not detect the existence of the obstacle in the region for a predetermined time after the display mode of the guide line is changed.

Accordingly, the guide line can be made conspicuous during a period in which the guide line does not overlap with the obstacle.

In the configuration described above, the display processing unit may display the guide line having a shape in which a line segment parallel to a direction of the mobile body and a line segment perpendicular to the direction of the mobile body are combined. In the configuration described above, the change unit changes the display mode while maintaining the shape of the guide line.

Accordingly, the display mode can be changed and the visibility can be improved while maintaining a function as a fixed guide line having a shape that is not changed.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A surrounding display device comprising:
a display processing unit that causes a display device to display a display image in which a guide line is superimposed on a surrounding image indicating a situation in surroundings of a mobile body;
a detection unit that detects existence of an obstacle in a region specified by the guide line; and
a change unit that changes a display mode of the guide line such that a salience of the guide line decreases when the detection unit detects the existence of the obstacle in the region.

2. The surrounding display device according to claim 1,
wherein the change unit increases a transmittance of the guide line.

3. The surrounding display device according to claim 1,
wherein the change unit returns the display mode of the guide line to a state before the change when the detection unit does not detect the existence of the obstacle in the region for a predetermined time after the display mode of the guide line is changed.

4. The surrounding display device according to claim 1,
wherein the display processing unit displays the guide line having a shape in which a line segment parallel to a direction of the mobile body and a line segment perpendicular to the direction of the mobile body are combined.
